(19) United States
(12) Patent Application Publication
(10) Pub. No.: US 2026/0281016 A1
(43) Pub. Date: Sep. 17, 2026

(54) SYSTEM FOR ANALYZING LOG DATA

(71) Applicant: SoftBank Group Corp., Tokyo (JP)

(72) Inventor: Shumpei MASUDA, Tokyo (JP)

(21) Appl. No.: 19/562,776

(22) Filed: Mar. 11, 2026

Related U.S. Application Data
(60) Provisional application No. 63/770,430, filed on Mar. 12, 2025.

(51) Int. Cl. H04L 43/045; H04L 43/02

(52) U.S. Cl. CPC H04L 43/045; H04L 43/02

(57) ABSTRACT

A data collection unit centrally collects log data from routers, switches, firewalls, and the like, and a data conversion unit converts this into a unified format. A data analysis unit including a generative AI analyzes the log data based on a user's natural language query and performs anomaly detection and trend analysis. The analysis result is provided to the user via a data output unit and is visualized as a table or a graph.

### CROSS-REFERENCE TO RELATED APPLICATION

This application claims the benefit of priority from U.S. Provisional Patent Application No. 63/770,430, filed on Mar. 12, 2025. The entire contents of the priority application are incorporated herein by reference.

### BACKGROUND

The technology of the present disclosure relates to a system.

Japanese Unexamined Patent Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

The problem to be solved by this discloser is the efficient analysis and management of vast amounts of log data acquired from network devices. Network devices are diverse, and since the format and content of log data differ depending on each vendor, it is extremely difficult to centrally analyze these data. In related art methods, the task of manually checking log data in different formats and extracting necessary information requires time and effort, and increases the risk of errors occurring or important information being overlooked.

Furthermore, in network operation management, real-time monitoring and prompt troubleshooting are required, but it is not easy to quickly extract necessary information from vast amounts of log data. For this reason, an efficient means for accurately grasping the state of the network and discovering and resolving problems early is needed.

This discloser utilizes generative AI to automatically analyze log data, and enables a user to quickly and accurately extract necessary information by inputting a query in natural language. This makes it possible to centrally manage and analyze log data from devices of different vendors, and to significantly improve the efficiency of network monitoring and troubleshooting. Therefore, this discloser provides an effective solution for reducing the burden of data analysis in network operation management and supporting prompt decision-making.

As a means for solving the problem, the present discloser provides a system for efficiently analyzing log data acquired from network devices and quickly extracting necessary information. This system includes a data collection unit, a data conversion unit, a data analysis unit, and a data output unit.

The data collection unit has a function of acquiring log data from network devices of a plurality of different vendors, and this makes it possible to centrally collect log data in different formats. Next, the data conversion unit converts the collected log data into a standardized intermediate format. This intermediate format is designed to be easily analyzed by a generative AI, and can handle data in different formats in a unified manner.

The data analysis unit includes a generative AI and accepts a query in natural language from a user. The AI analyzes the query using natural language processing technology and quickly extracts relevant information from the log data. This process enables the user to efficiently acquire necessary information from the vast amount of log data.

Finally, the data output unit has a function of providing an analysis result to the user. The extracted data is formatted into a form that is easy for the user to understand, and can also be visualized in a tabular format or a graph format. This makes it possible to streamline network monitoring and troubleshooting and to support prompt decision-making. In this way, the present discloser provides a means for reducing the burden of data analysis in network operation management and realizing efficient information extraction.

Embodiments of the present disclosure address a technical problem that is practically impossible to perform in the human mind: normalizing and analyzing unstructured data flowing from heterogeneous data sources in real time. Specifically, processing that integrates multiple streams having different data formats without delay and adapts them as input for a machine learning model has been a bottleneck in conventional general-purpose database management systems. The present disclosure achieves high-precision anomaly detection and prediction while suppressing consumption of computing resources (CPU/memory) by organically combining a specific data conversion pipeline and an analysis algorithm.

### BRIEF DESCRIPTION OF DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example of a method for analyzing log data.

### DETAILED DESCRIPTION

Hereinafter, an example of an embodiment of a system according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### First Embodiment

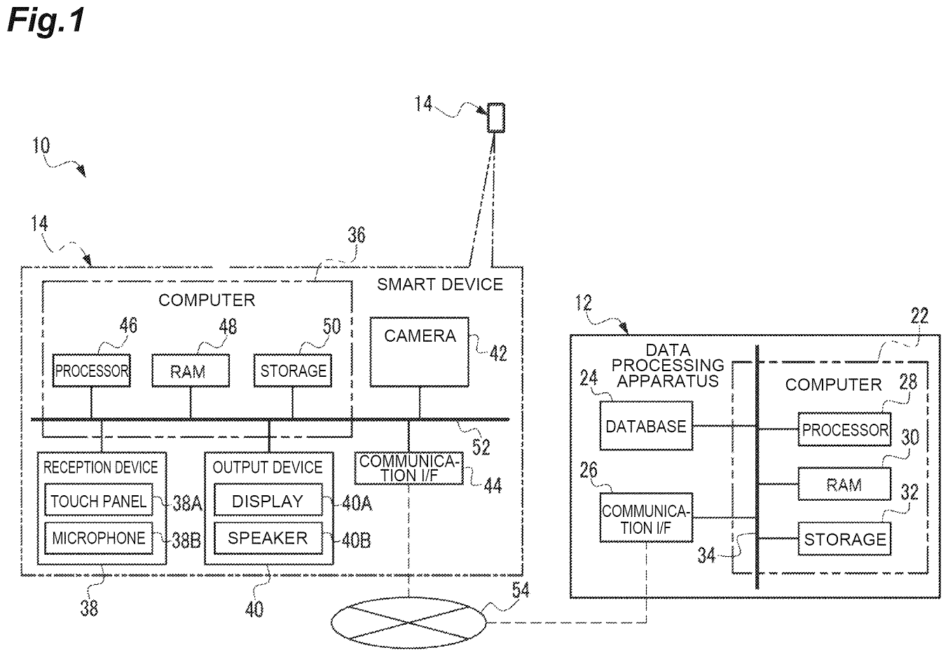

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

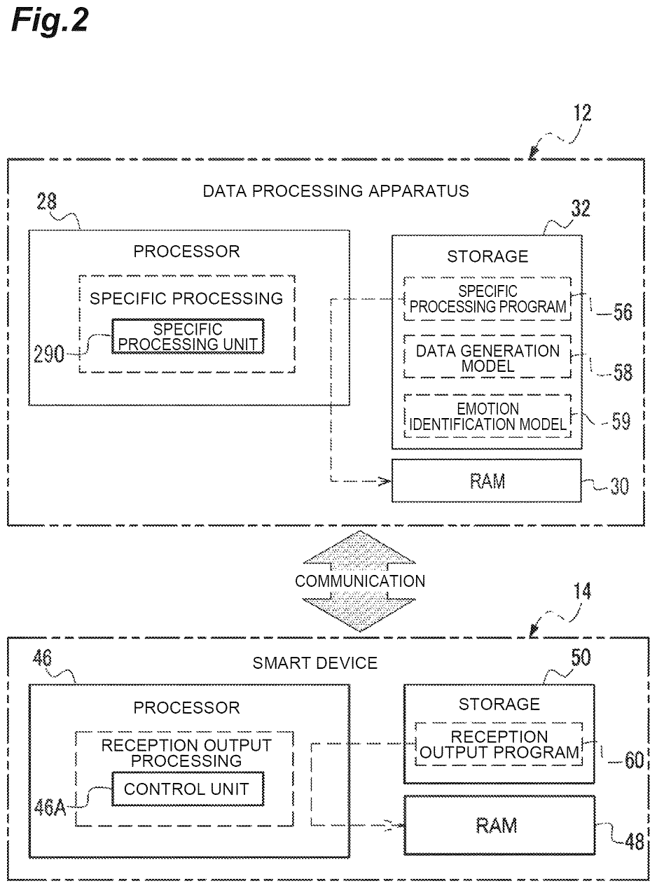

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present discloser is not limited to such an example. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the specific processing program 60 executed on the RAM 48. Note that the smart device 14 can also have a data generation model and an emotion identification model similar to the data generation model 58 and the emotion identification model 59, and perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### Example 1

A flow of specific processing in Example 1 will be described. Each unit of the system described below is realized by the data processing apparatus 12 and the smart device 14. Also, the data processing apparatus 12 is referred to as a “server”, and the smart device 14 is referred to as a “terminal”.

### Embodiment

An embodiment will be described more specifically and in detail. This system is constructed using a server and a terminal, and each unit fulfills its respective role to efficiently manage and analyze log data from network devices.

First, the data collection unit is arranged on a server. The data collection unit may be configured by, for example, a specific processing unit 290, a specific processing program 56, and a data generation model 58. This unit provides an interface for acquiring log data from network devices. Specifically, logs are received in real time from routers and switches using the Syslog protocol, and event information is acquired from firewalls using SNMP traps. It is also possible to collect log data from cloud-based network services via an API. This makes it possible to centrally collect log data output from devices of different vendors and in different formats and with different protocols.

The data collection unit may execute asynchronous I/O processing using a ring buffer structure when acquiring raw data such as packets on a network, log files, or sensor signals. This prevents data loss even during burst traffic inflows while smoothing the handover to subsequent processing. Further, the data collection unit may perform indexing on the acquired data based on timestamps at a hardware level (e.g., utilizing a timestamp function of a Network Interface Card (NIC)); in this case, time-series consistency of the analysis can be guaranteed.

Next, the data conversion unit is also implemented on the server. The data conversion unit may be configured by, for example, the specific processing unit 290, the specific processing program 56, and the data generation model 58. This unit has a function of converting the collected log data into a unified intermediate format. For example, when converting log data acquired in CSV format to JSON format, each field is mapped to a key-value pair, and the timestamp is unified to the ISO 8601 format. It also analyzes the content of log messages, extracts important information, and performs tagging. This improves the accuracy and efficiency when the generative AI analyzes the data.

The data conversion unit may execute preprocessing to convert collected raw data into a format (e.g., multidimensional vectors) processable by a data analysis unit described later. Specifically, vectorization may be performed on text data using embedding technologies such as Word2Vec or BERT, and Z-score normalization or Min-Max scaling may be applied to numerical data. Furthermore, the data conversion unit may have a filtering function that applies an imputation algorithm using k-nearest neighbors (k-NN) to records containing missing values, thereby removing noise that degrades analysis accuracy.

The data analysis unit includes a generative AI and operates on the server. The data analysis unit may be configured by, for example, the specific processing unit 290, the specific processing program 56, and the data generation model 58. This unit processes queries in natural language from a user and analyzes the log data. For example, when a user inputs “Show me all error logs that occurred on Oct. 1, 2023,” the AI filters the logs for the corresponding date based on the timestamp and extracts the log entries that include an error message. Furthermore, the AI can use machine learning algorithms to recognize patterns in the log data and perform anomaly detection and trend analysis. For example, it also has a function to generate an alert when access from a specific IP address suddenly increases.

The data analysis unit may perform feature extraction using a Convolutional Neural Network (CNN) or a Recurrent Neural Network (RNN) based on the converted vector data. For example, in the analysis of time-series data, a model including a Long Short-Term Memory (LSTM) layer may be used to learn both short-term fluctuations and long-term trends. The data analysis unit may include a process of calculating a risk value or an anomaly degree of input data using a trained model and statistically testing whether the result is within a Confidence Interval.

The data analysis unit may adopt a neural network model based on a Transformer architecture (e.g., BERT or a lightweight model thereof) in Natural Language Processing (NLP). Specifically, the unit tokenizes collected text data and generates contextual embedding vectors for each word using a multi-layer Self-Attention mechanism. Through this process, the unit quantitatively identifies not merely keyword matching but the surrounding context (e.g., whether a statement is a joke or an actual threat) as a distance in a vector space. This vector operation is executed on a parallel processing processor such as a GPU or TPU (Tensor Processing Unit), thereby offloading the load on the CPU and reducing the latency of the entire system.

The data output unit is related to both the server and the terminal. The data output unit may be configured by, for example, the specific processing unit 290, the specific processing program 56, the data generation model 58, a computer 36, and an output device 40. The server generates an analysis result and transmits it to the terminal. The terminal displays the result through a user interface. Specifically, the extracted data is organized in a tabular format, and important information is highlighted. Also, by visualizing the data as graphs or charts, it enables the user to intuitively understand data trends and anomalies. Furthermore, the user can also filter the analysis results or export them as a report in PDF or CSV format through the terminal.

The data output unit may issue active control commands to external systems, rather than merely performing screen display, based on the analysis results. Specifically, the operations may include: (1) execution of an API call that dynamically updates firewall settings upon anomaly detection; (2) transmission of a forced termination signal for a specific process or thread; or (3) transmission of a traffic route change instruction to a load balancer. These operations are automatically executed without human intervention to immediately restore the safety or stability of the entire system.

In this way, the present discloser realizes a system that combines a server and a terminal to efficiently collect, convert, and analyze log data from network devices, and to provide prompt and accurate information to a user. This system significantly streamlines network monitoring and troubleshooting, and reduces the burden of operation management. Furthermore, through anomaly detection and trend analysis, it is possible to improve network security and performance.

### (System Configuration)

The system according to the present embodiment includes a data collection unit, a data conversion unit, a data analysis unit, and a data output unit. The data collection unit has a function of acquiring log data from network devices. This unit can receive logs in real time from network devices such as routers, switches, and firewalls using the Syslog protocol. It is also possible to acquire event information using SNMP traps. Furthermore, it is also possible to collect log data from cloud-based network services via an API. This makes it possible to centrally collect log data output by different vendors and with different protocols.

The data conversion unit has a function of converting the collected log data into a unified intermediate format. This unit, for example, when converting log data acquired in CSV format to JSON format, maps each field to a key-value pair and unifies the timestamp to the ISO 8601 format. It also analyzes the content of log messages, extracts important information, and performs tagging. This improves the accuracy and efficiency when the generative AI analyzes the data. Furthermore, since data in different formats can be handled in a unified manner, consistency of analysis is maintained.

The data analysis unit includes a generative AI, processes queries in natural language from a user, and analyzes the log data. This unit, for example, when a user inputs “Show me all error logs that occurred on Oct. 1, 2023,” filters the logs for the corresponding date based on the timestamp and extracts the log entries that include an error message. Furthermore, the AI can use machine learning algorithms to recognize patterns in the log data and perform anomaly detection and trend analysis. For example, it also has a function to generate an alert when access from a specific IP address suddenly increases. Also, the AI can perform a detailed analysis to identify the cause of a specific network event based on the user's query.

The data output unit has a function of providing an analysis result to a user. This unit is related to both a server and a terminal, and the server generates an analysis result and transmits it to the terminal. The terminal displays the result through a user interface. Specifically, the extracted data is organized in a tabular format, and important information is highlighted. Also, by visualizing the data as graphs or charts, it enables the user to intuitively understand data trends and anomalies. Furthermore, the user can also filter the analysis results or export them as a report in PDF or CSV format through the terminal.

Specific examples of prompt sentences to be read into the generative AI necessary for carrying out the present discloser include “Search all logs related to a specific IP address, detect and report any abnormal patterns” and “List all security-related events that have occurred within the past 24 hours and display those with high impact in order of priority”. With these prompt sentences, the AI can quickly and accurately analyze log data and provide necessary information in response to a user's request. In this way, the system according to the present embodiment makes it possible to efficiently collect, convert, and analyze log data from network devices, and to provide prompt and accurate information to the user.

### (Implementation Steps)

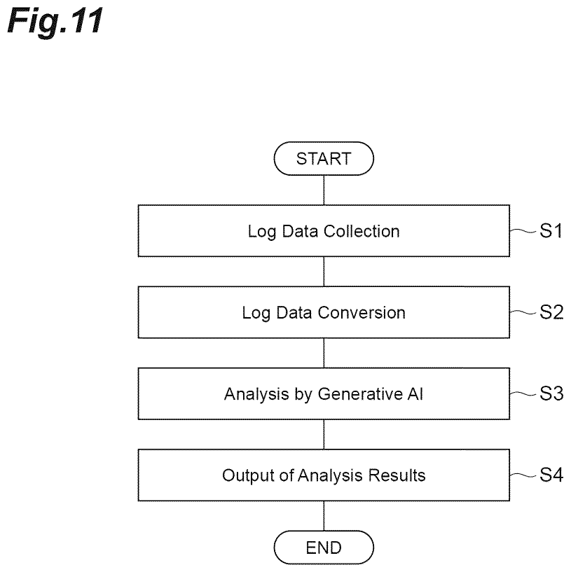

Step 1: Log Data Collection (see Step S1 in FIG. 11) This is a step of collecting log data from network devices. In this step, logs are received in real time from network devices such as routers, switches, and firewalls using the Syslog protocol. It is also possible to acquire event information using SNMP traps. Furthermore, it is also possible to collect log data from cloud-based network services via an API. This makes it possible to centrally collect log data output in different formats and with different protocols.

Step 2: Log Data Conversion (see Step S2 in FIG. 11) This is a step of converting the collected log data into a unified intermediate format. In this step, for example, when converting log data acquired in CSV format to JSON format, each field is mapped to a key-value pair, and the timestamp is unified to the ISO 8601 format. It also analyzes the content of log messages, extracts important information, and performs tagging. This improves the accuracy and efficiency when the generative AI analyzes the data.

Step 3: Analysis by Generative AI (see Step S3 in FIG. 11) This is a step of analyzing log data using a generative AI. In this step, a query in natural language from a user is processed, and the log data is analyzed. For example, when a user inputs “Show me all error logs that occurred on Oct. 1, 2023,” the AI filters the logs for the corresponding date based on the timestamp and extracts the log entries that include an error message. Furthermore, the AI can use machine learning algorithms to recognize patterns in the log data and perform anomaly detection and trend analysis. Specific examples of prompt sentences to be read into the generative AI include “Search all logs related to a specific IP address, detect and report any abnormal patterns” and “List all security-related events that have occurred within the past 24 hours and display those with high impact in order of priority”.

Step 4: Output of Analysis Results (see Step S4 in FIG. 11) This is a step of providing an analysis result to a user. In this step, a server generates an analysis result and transmits it to a terminal. The terminal displays the result through a user interface. Specifically, the extracted data is organized in a tabular format, and important information is highlighted. Also, by visualizing the data as graphs or charts, it enables the user to intuitively understand data trends and anomalies. Furthermore, the user can also filter the analysis results or export them as a report in PDF or CSV format through the terminal.

### (Specific Use Case)

For example, consider a case where a network administrator of a certain company utilizes the present discloser to enhance the security of the company's internal network. This company uses routers, switches, and firewalls provided by multiple vendors, and log data is generated from each device in a different format. The network administrator needs to efficiently analyze these log data and discover potential security threats early.

First, the data collection unit receives logs in real time from network devices using the Syslog protocol. It also acquires event information using SNMP traps and collects log data from cloud-based network services via an API. This makes it possible to centrally collect log data output by different vendors and with different protocols.

Next, the data conversion unit converts the collected log data into a unified intermediate format. For example, it converts log data acquired in CSV format to JSON format, maps each field to a key-value pair, and unifies the timestamp to the ISO 8601 format. It also analyzes the content of log messages, extracts important information, and performs tagging.

Then, the data analysis unit analyzes the log data using a generative AI. The network administrator inputs a prompt to the generative AI, such as “List all security-related events that have occurred within the past 24 hours and display those with high impact in order of priority”. The AI uses machine learning algorithms to recognize patterns in the log data and perform anomaly detection and trend analysis. For example, it also has a function to generate an alert when access from a specific IP address suddenly increases.

Finally, the data output unit provides the analysis result to the user. The analysis result is transmitted from a server to a terminal and displayed through a user interface. Specifically, the extracted data is organized in a tabular format, and important information is highlighted. Also, by visualizing the data as graphs or charts, it enables the network administrator to intuitively understand data trends and anomalies. Furthermore, the network administrator can also filter the analysis results or export them as a report in PDF or CSV format.

In this way, the present discloser makes it possible to efficiently collect, convert, and analyze log data from network devices, and to provide prompt and accurate information to a user. This significantly streamlines network monitoring and troubleshooting, and reduces the burden of operation management.

(Application Example 1) A flow of specific processing in Application Example 1 will be described. Each unit of the system described below is realized by the data processing apparatus 12 and the smart device 14. Also, the data processing apparatus 12 is referred to as a “server”, and the smart device 14 is referred to as a “terminal”.

### Embodiment

An embodiment will be described more specifically and in detail. This system is designed to improve operational efficiency within a data center and includes a data collection unit, a data conversion unit, a data analysis unit, and a data output unit.

First, the data collection unit has a function of collecting log data from various devices within a data center. This unit acquires data from all devices in the data center, such as servers, network devices, storage devices, and cooling systems. Specifically, it acquires data on CPU usage, memory usage, and disk I/O from servers. For example, if the CPU usage of a server exceeds a certain threshold, it can detect an overload condition and issue an alert. It collects traffic data and packet loss rates from network devices. For example, if network traffic suddenly increases, it provides information for identifying a bottleneck and taking appropriate measures. It also acquires data on capacity usage and access speed from storage devices to optimize storage. It acquires temperature data and energy consumption in real time from cooling systems to aim for improvement in cooling efficiency.

Next, the data conversion unit has a function of converting the collected log data into a unified format. This unit arranges the log data provided in different formats into a form that is easy to analyze. For example, if logs from a server are provided in text format and logs from a network device are provided in JSON format, it converts them into a common data model and unifies the timestamp to the ISO 8601 format. It also improves efficiency in subsequent analysis steps by adding tags to important events and error messages. This makes it possible to handle data output by different vendors and with different protocols in a consistent manner.

The data analysis unit analyzes the log data converted into the unified format using a generative AI. This unit utilizes AI to monitor the operational status of the data center in real time and detect abnormal patterns and trends. For example, when the load on a specific server rapidly increases, when a network delay occurs, or when storage capacity is tight, the AI detects these anomalies and generates an alert. The AI can also make proposals regarding the optimization of energy consumption and the efficiency of the cooling system. Specific prompt sentences may include, for example, “Identify servers whose CPU usage has exceeded 80% in the past hour and propose load balancing” and “Analyze the temperature data of the cooling system and propose optimal settings to improve energy efficiency”.

Finally, the data output unit provides the analysis result to the data center administrator. This unit visualizes the analysis result so that the administrator can intuitively understand it. For example, it identifies servers with high loads and provides information for reallocating resources, or presents specific measures for reducing energy consumption. The administrator can also make decisions to optimize the operation of the data center based on the analysis results. This improves the reliability and performance of the data center and also contributes to the reduction of operational costs.

In this way, the present discloser provides a system that efficiently collects, converts, and analyzes vast amounts of log data generated from various devices in a data center, and enables optimization of operations and early detection of failures. This improves the operational efficiency of the data center and enables early detection of failures and prompt response.

### (System Configuration)

The system according to the present embodiment includes a data collection unit, a data conversion unit, a data analysis unit, and a data output unit. The data collection unit has a function of collecting log data from various devices within a data center. This unit acquires data from all devices in the data center, such as servers, network devices, storage devices, and cooling systems. Specifically, it acquires data on CPU usage, memory usage, and disk I/O from servers. For example, if the CPU usage of a server exceeds a certain threshold, it can detect an overload condition and issue an alert. It collects traffic data and packet loss rates from network devices. For example, if network traffic suddenly increases, it provides information for identifying a bottleneck and taking appropriate measures. It also acquires data on capacity usage and access speed from storage devices to optimize storage. It acquires temperature data and energy consumption in real time from cooling systems to aim for improvement in cooling efficiency.

The data conversion unit has a function of converting the collected log data into a unified format. This unit arranges the log data provided in different formats into a form that is easy to analyze. For example, if logs from a server are provided in text format and logs from a network device are provided in JSON format, it converts them into a common data model and unifies the timestamp to the ISO 8601 format. It also improves efficiency in subsequent analysis steps by adding tags to important events and error messages. This makes it possible to handle data output by different vendors and with different protocols in a consistent manner.

The data analysis unit analyzes the log data converted into the unified format using a generative AI. This unit utilizes AI to monitor the operational status of the data center in real time and detect abnormal patterns and trends. For example, when the load on a specific server rapidly increases, when a network delay occurs, or when storage capacity is tight, the AI detects these anomalies and generates an alert. The AI can also make proposals regarding the optimization of energy consumption and the efficiency of the cooling system. Specific prompt sentences may include, for example, “Identify servers whose CPU usage has exceeded 80% in the past hour and propose load balancing” and “Analyze the temperature data of the cooling system and propose optimal settings to improve energy efficiency”.

The data output unit provides the analysis result to the data center administrator. This unit visualizes the analysis result so that the administrator can intuitively understand it. For example, it identifies servers with high loads and provides information for reallocating resources, or presents specific measures for reducing energy consumption. The administrator can also make decisions to optimize the operation of the data center based on the analysis results. This improves the reliability and performance of the data center and also contributes to the reduction of operational costs.

In this way, the system according to the present embodiment makes it possible to efficiently collect, convert, and analyze vast amounts of log data generated from various devices in a data center, and to enable optimization of operations and early detection of failures. This improves the operational efficiency of the data center and enables early detection of failures and prompt response.

### (Implementation Steps)

### Step 1: Log Data Collection

This is a step of collecting log data from various devices within a data center. In this step, data is acquired from servers, network devices, storage devices, cooling systems, and the like. Specifically, data on CPU usage, memory usage, and disk I/O are collected in real time from servers. Traffic data and packet loss rates are acquired from network devices, and data on capacity usage and access speed are collected from storage devices. Temperature data and energy consumption are acquired from cooling systems, and based on these data, basic data for grasping the overall operational status of the data center is collected.

### Step 2: Log Data Conversion

This is a step of converting the collected log data into a unified format. In this step, log data provided in different formats is arranged into a form that is easy to analyze. For example, if logs from a server are provided in text format and logs from a network device are provided in JSON format, they are converted into a common data model, and the timestamp is unified to the ISO 8601 format. It also improves efficiency in subsequent analysis steps by adding tags to important events and error messages. This makes it possible to handle data output by different vendors and with different protocols in a consistent manner.

### Step 3: Analysis by Generative AI

This is a step of analyzing log data using a generative AI. In this step, the AI monitors the operational status of the data center in real time and detects abnormal patterns and trends. For example, when the load on a specific server rapidly increases, when a network delay occurs, or when storage capacity is tight, the AI detects these anomalies and generates an alert. The AI can also make proposals regarding the optimization of energy consumption and the efficiency of the cooling system. Specific prompt sentences may include, for example, “Identify servers whose CPU usage has exceeded 80% in the past hour and propose load balancing” and “Analyze the temperature data of the cooling system and propose optimal settings to improve energy efficiency”.

### Step 4: Output of Analysis Results

This is a step of providing an analysis result to the data center administrator. In this step, the analysis result is visualized so that the administrator can intuitively understand it. Specifically, it identifies servers with high loads and provides information for reallocating resources, or presents specific measures for reducing energy consumption. The administrator can also make decisions to optimize the operation of the data center based on the analysis results. This improves the reliability and performance of the data center and also contributes to the reduction of operational costs.

### (Specific Use Case)

For example, consider a case where the present discloser is implemented in a large-scale data center for the purpose of improving operational efficiency and early detection of failures. This data center is equipped with hundreds of servers, multiple network devices, extensive storage devices, and an advanced cooling system. The log data generated from these devices is vast, and with related art methods, analysis takes time, and there is a risk of delayed detection of anomalies.

The data collection unit collects data on CPU usage, memory usage, and disk I/O from servers in real time. For example, if the CPU usage on a specific server rapidly increases, it can detect an overload condition and immediately issue an alert. It collects traffic data and packet loss rates from network devices to monitor the health of the network. For example, if traffic suddenly increases, it provides information for identifying a bottleneck and taking appropriate measures. It acquires data on capacity usage and access speed from storage devices to optimize storage. It acquires temperature data and energy consumption from cooling systems to aim for improvement in cooling efficiency.

The data conversion unit converts the collected log data into a unified format. For example, if logs from a server are provided in text format and logs from a network device are provided in JSON format, it converts them into a common data model and unifies the timestamp to the ISO 8601 format. It also improves efficiency in subsequent analysis steps by adding tags to important events and error messages.

The data analysis unit using a generative AI analyzes the log data converted into the unified format. The AI monitors the operational status of the data center in real time and detects abnormal patterns and trends. For example, if the load on a specific server rapidly increases, the AI detects this and generates an alert. The AI can also make proposals regarding the optimization of energy consumption and the efficiency of the cooling system. Specific prompt sentences may include, for example, “Identify servers whose CPU usage has exceeded 80% in the past hour and propose load balancing” and “Analyze the temperature data of the cooling system and propose optimal settings to improve energy efficiency”.

The data output unit provides the analysis result to the data center administrator. The analysis result is visualized so that the administrator can intuitively understand it. For example, it identifies servers with high loads and provides information for reallocating resources, or presents specific measures for reducing energy consumption. The administrator can also make decisions to optimize the operation of the data center based on the analysis results.

In this way, by using the present discloser, the operational efficiency of the data center is improved, and early detection of failures and prompt response become possible. This improves the reliability and performance of the data center and also contributes to the reduction of operational costs.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present discloser is not limited to such an example. Also, the AI may be an AI agent. Also, when the processing of each unit described above is performed by an AI, the processing is partially or entirely performed by the AI, but the present discloser is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart device 14.

### Second Embodiment

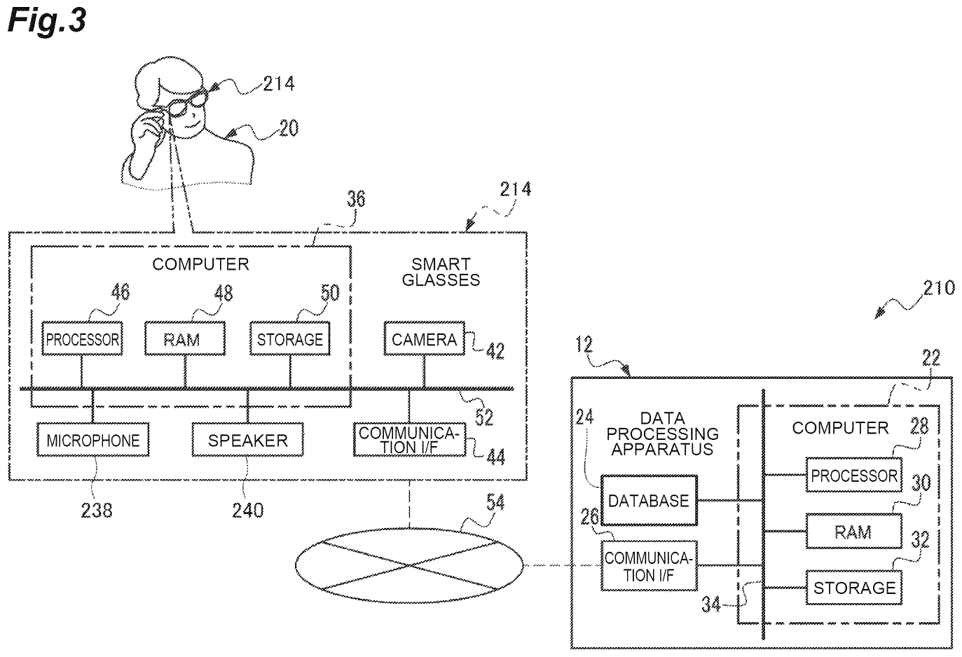

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

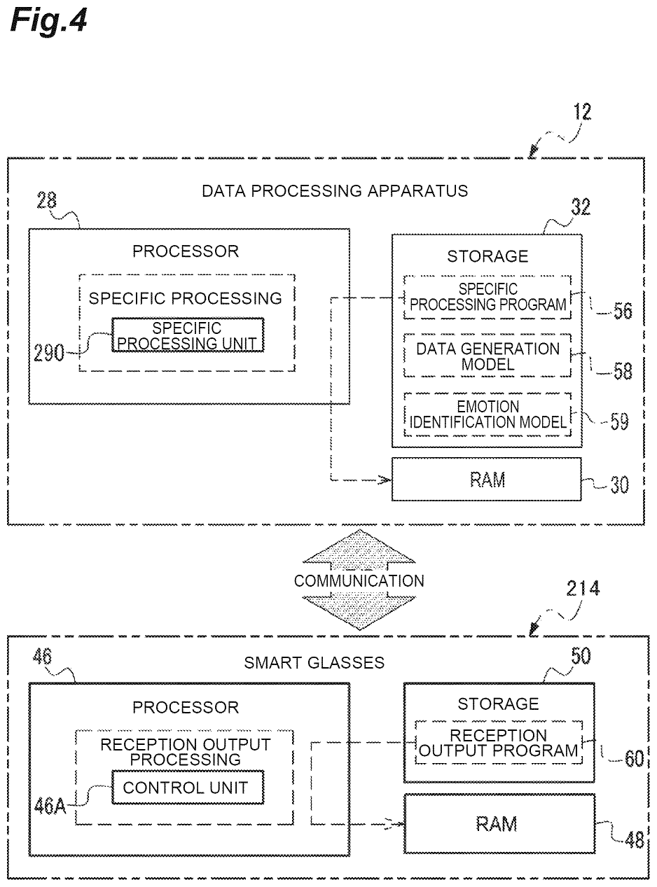

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present discloser is not limited to such an example. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present discloser is not limited to such an example. Also, the AI may be an AI agent. Also, when the processing of each unit described above is performed by an AI, the processing is partially or entirely performed by the AI, but the present discloser is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart glasses 214.

### Third Embodiment

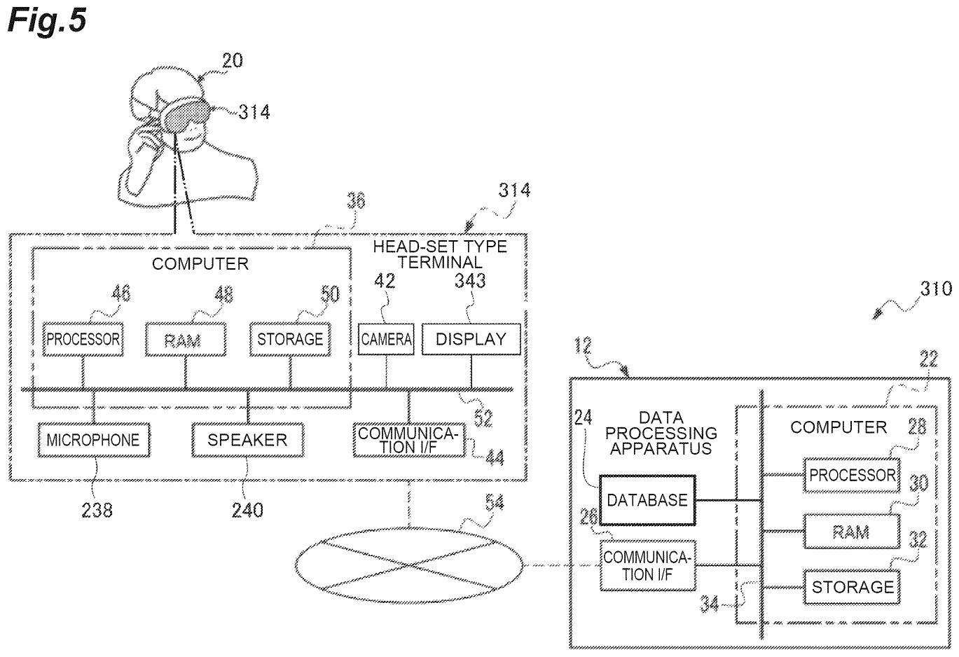

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

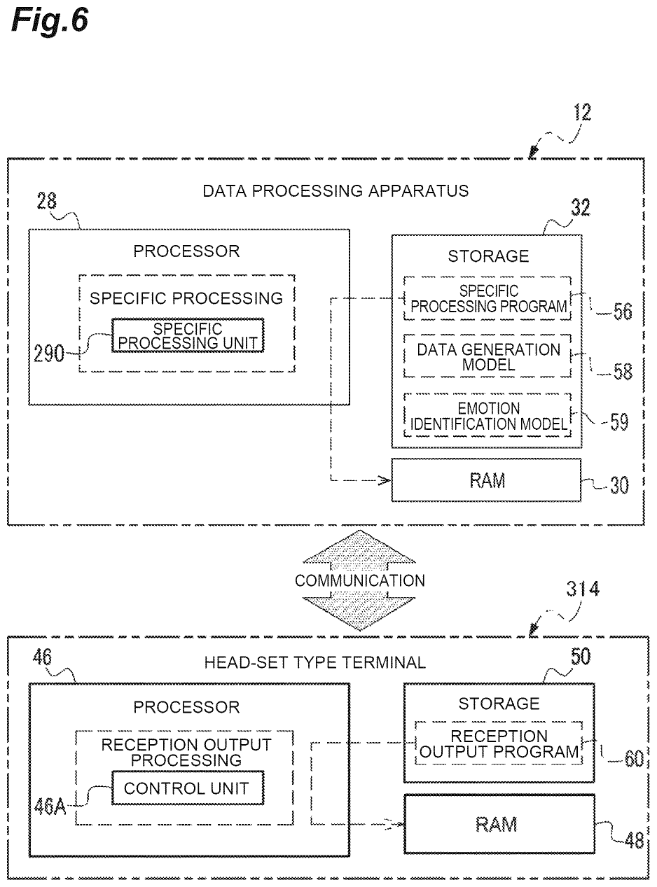

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present discloser is not limited to such an example. Also, the AI may be an AI agent. Also, when the processing of each unit described above is performed by an AI, the processing is partially or entirely performed by the AI, but the present discloser is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the headset-type terminal 314.

### Fourth Embodiment

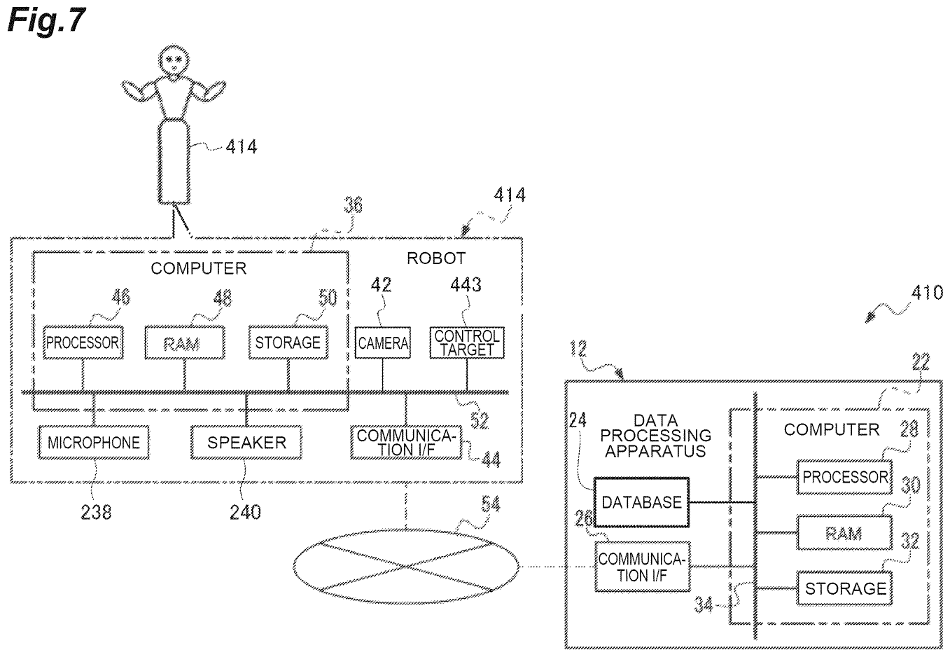

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

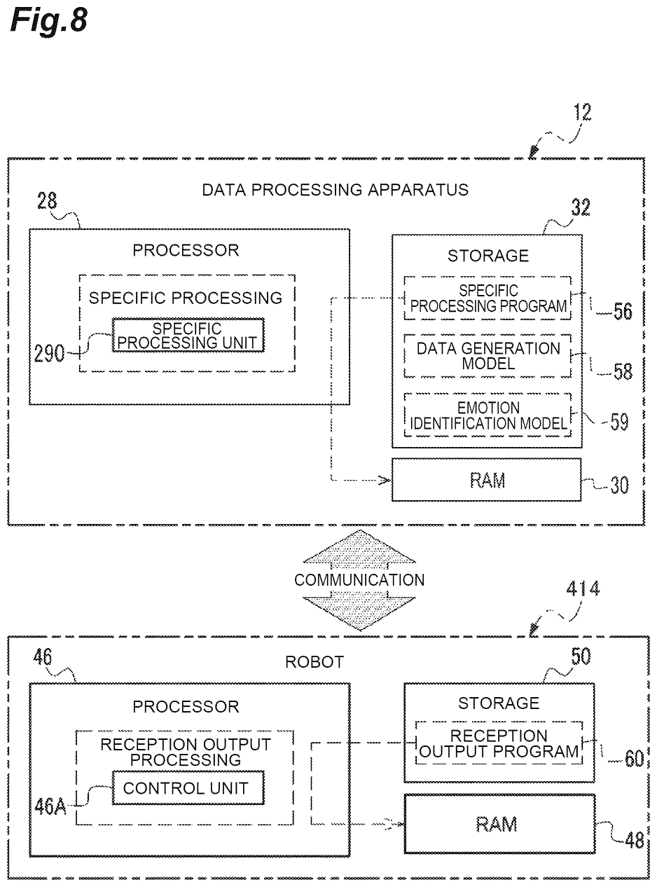

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present discloser is not limited to such an example. Also, the AI may be an AI agent. Also, when the processing of each unit described above is performed by an AI, the processing is partially or entirely performed by the AI, but the present discloser is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the robot 414.

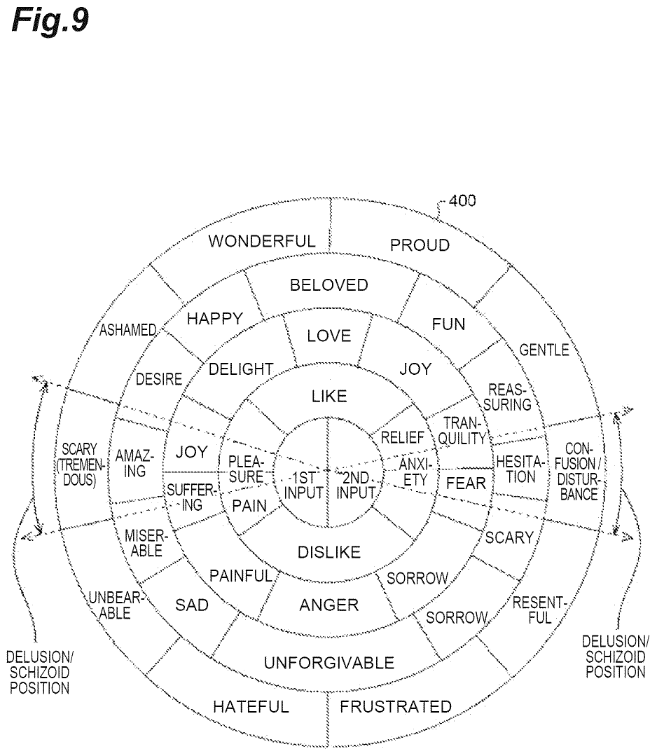

Note that the emotion identification model 59 as an emotion engine may determine a user's emotion according to a specific mapping. Specifically, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

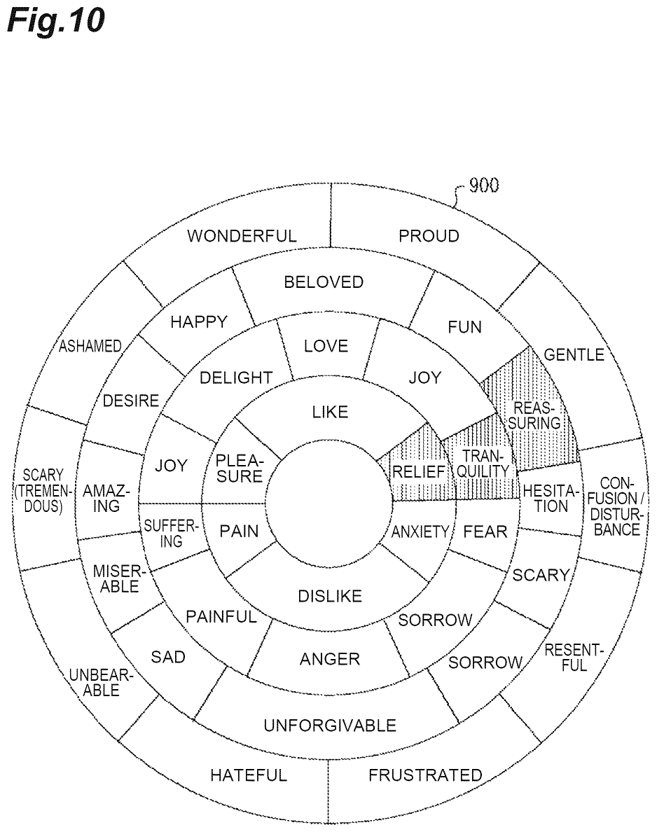

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a Saas (Software as a Service) format.

In the above embodiment, an example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

In the above embodiment, an example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, more specifically, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent-application, and technical standard were specifically and individually indicated to be incorporated by reference.

Regarding the above embodiments, the following is further disclosed.

### Application Example 1

A system comprising a data collection unit, a data conversion unit, a data analysis unit, and a data output unit. The data collection unit has a function of collecting log data from servers, network devices, storage devices, cooling systems, and the like in a data center, whereby it is possible to centrally collect log data output by different vendors and with different protocols. The data conversion unit has a function of converting the collected log data into a unified format and arranging it into a form that is easy to analyze, and converts data in different formats into a common data model and unifies timestamps. The data analysis unit has a function of analyzing log data using a generative AI and detecting abnormal patterns and trends, and the AI uses a machine learning algorithm to monitor the operational status of the data center in real time and generate alerts. The data output unit has a function of providing analysis results to a data center administrator, visualizing the analysis results, and enabling the administrator to intuitively understand them.

The system, wherein the data collection unit has a function of acquiring, in real time, CPU usage, memory usage, and disk I/O of a server, network traffic data, storage capacity usage status, and temperature data of a cooling system, whereby it is possible to collect basic data for grasping the overall operational status within the data center.

The system, wherein the data analysis unit has a function in which, when the load on a specific server rapidly increases, when a network delay occurs, or when storage capacity is tight, the AI detects these anomalies and generates an alert, and can further make proposals regarding the optimization of energy consumption and the efficiency of the cooling system.

A system for analyzing log data, comprising circuitry, wherein the circuitry is configured to: collect log data acquired from network equipment; convert the collected log data into a unified format; analyze the converted log data using a generative AI; and provide an analysis result to a user.

The system, wherein the circuitry is configured to: acquire the log data from the network equipment of a plurality of different vendors; convert the acquired log data into a standardized intermediate format; accept a query in natural language from the user; extract corresponding log data; and visualize the extracted log data in a tabular format or a graph format and provide the visualized log data to the user.

The system, wherein the circuitry is configured to: analyze the query of the user using natural language processing technology; extract relevant information from the log data; and format the extracted log data into a format understandable by the user.

The system, wherein the circuitry is configured to highlight specific information.

A method for analyzing log data, the method comprising: collecting log data acquired from network equipment; converting the collected log data into a unified format; analyzing the converted log data using a generative AI; and providing an analysis result to a user.

1. A system for analyzing log data, comprising circuitry,
wherein the circuitry is configured to:
collect log data acquired from network equipment;
convert the collected log data into a unified format;
analyze the converted log data using a generative AI; and
provide an analysis result to a user.

2. The system according to claim 1, wherein the circuitry is configured to:
acquire the log data from the network equipment of a plurality of different vendors;
convert the acquired log data into a standardized intermediate format;
accept a query in natural language from the user;
extract corresponding log data; and
visualize the extracted log data in a tabular format or a graph format and provide the visualized log data to the user.

3. The system according to claim 1, wherein the circuitry is configured to:
analyze the query of the user using natural language processing technology;
extract relevant information from the log data; and
format the extracted log data into a format understandable by the user.

4. The system according to claim 1, wherein the circuitry is configured to highlight specific information.

5. A method for analyzing log data, the method comprising:
collecting log data acquired from network equipment;
converting the collected log data into a unified format;
analyzing the converted log data using a generative AI; and
providing an analysis result to a user.
